(19) United States
(12) Patent Application Publication
(10) Pub. No.: US 2024/0044841 A1
(43) Pub. Date: Feb. 8, 2024

(54) CHARACTERISATION OF HIGH MASS PARTICLES

(71) Applicant: Micromass UK Limited, Wilmslow (GB)

(72) Inventors: Jakub Ujma, Wilmslow (GB); David Langridge, Wilmslow (GB); Jason Wildgoose, Wilmslow (GB); Keith Richardson, Wilmslow (GB); Kevin Giles, Wilmslow (GB)

(73) Assignee: Micromass UK Limited, Wilmslow (GB)

(21) Appl. No.: 18/259,012

(22) PCT Filed: Dec. 23, 2021
(86) PCT No.: PCT/GB2021/053426

§ 371 Date: Jun. 22, 2023

(30) Foreign Application Priority Data
Dec. 24, 2020 (GB) 2020575.3
May 13, 2021 (GB) 2106850.7

(51) Int. Cl. G01N 27/623

(52) U.S. Cl. CPC G01N 27/623

(57) ABSTRACT

A method of analysing high-mass (>1 MDa) particles comprises ionising particles to as to produce ions, separating the ions according to mass to charge ratio by passing the ions through an ion separation device in which one or more time-varying electric fields is used to urge ions through a gas such that ions are separated according to mass to charge ratio, measuring the transit time of the ions through the ion separation device, and determining a drift time or mass to charge ratio distribution of the ions therefrom. The method further comprises identifying one or more charge envelopes in the drift time or mass to charge ratio distribution, and using the one or more charge envelopes to characterise the particles.

### CROSS-REFERENCE TO RELATED APPLICATION

None.

### FIELD OF THE INVENTION

The present invention relates generally to methods of analysing particles, and in particular to methods of analysing particles using mass and/or ion mobility spectrometry.

### BACKGROUND

In general, it is considered that conventional mass spectrometers, which are configured to separate ions according to their mass to charge ratio (m/z), have limited utility in the analysis of high-mass particles (other than as a detector), since to derive mass information there must be some means of determining the charge state of the ions being analysed. This can be problematic for high-mass particles (which are usually highly charged), where the different charge states are relatively close in m/z, and where sample heterogeneity and/or adducting can render them unresolvable. Typically, this can be the case for particles with a mass >1 MDa.

The Applicant believes that there remains scope for improvements to methods of analysing high-mass particles.

### SUMMARY

According to an aspect, there is provided a method of analysing particles having mass >1 MDa, the method comprising:
ionising particles to as to produce ions;
separating the ions according to mass to charge ratio by passing the ions through an ion separation device in which one or more time-varying electric fields is used to urge ions through a gas such that ions are separated according to mass to charge ratio;
measuring the transit time of the ions through the ion separation device, and determining a drift time or mass to charge ratio distribution of the ions therefrom;
identifying one or more charge envelopes in the drift time or mass to charge ratio distribution; and
using the one or more charge envelopes to characterise the particles.

The Applicant has recognised that (as will be described further below) there are a number of circumstances where charge state resolution of ions is not required to characterise a mixture of high-mass (>1 MDa) particles, but where mere charge envelope resolution can provide sufficient information to be able to characterise the mixture of particles. Thus, in accordance with various embodiments, one or more charge envelopes are identified in a measured drift time or mass to charge ratio distribution, and the one or more charge envelopes are used to characterise a mixture of high-mass (>1 MDa) particles.

The Applicant has furthermore recognised that this means that mixtures of high-mass particles can be characterised using an analytical instrument that has a relatively low mass to charge ratio resolution. This in turn means that mixtures of high-mass particles can be characterised using an analytical instrument in which mass to charge ratio separation is achieved using an ion separation device in which one or more time-varying electric fields is used to urge ions through a gas (such as, for example, the ion separation device described in WO 2008/071967 (Micromass UK Limited), the contents of which are incorporated herein by reference).

Beneficially (and in contrast with conventional mass spectrometers), such an instrument does not require high vacuum pumping, does not require high voltages or high precision voltage control, and does not require a fast ion detector or fast signal digitisation. Various embodiments therefore provide a particularly simple and low-cost method of analysing high-mass particles, and a particularly simple and low-cost analytical instrument.

The drift time or mass to charge ratio distribution may comprise a drift time or mass to charge ratio distribution in which different charge states of the particles are unresolved. The drift time or mass to charge ratio distribution may comprise a drift time or mass to charge ratio distribution in which one or more, most, or each individual (resolved) peak in the distribution corresponds to a charge envelope for a particular particle in the mixture.

Using the one or more charge envelopes to characterise the particles may comprise using the one or more charge envelopes to characterise the particles without determining a charge or charge distribution of the particles. Using the one or more charge envelopes to characterise the particles may comprise only using the one or more charge envelopes to characterise the particles, such as using the one or more charge envelopes to characterise the particles without determining a charge, charge distribution, mass, or mass distribution of the particles.

The particles may comprise particles for which it is known or expected that ions produced from most or all of the particles (or from most or all of the particles of interest) have the same or similar average charge and/or the same or similar ion mobility (regardless of the mass).

Using the one or more charge envelopes to characterise the particles may comprise comparing the one or more charge envelopes to known charge envelope information, for example in a library of charge envelope information.

The particles may each have a mass >1 MDa. The particles may be a mixture of different particles, where each different particle has a different mass (>1 MDa). The mixture of particles may comprise a mixture of first particles having a first mass (>1 MDa) and second particles having a second different mass (>1 MDa). The mixture of particles may comprise one or more third particles having one or more third different masses (>1 MDa). The first mass may be greater than the second mass. The second mass may be greater than the one or more third masses.

Using the one or more charge envelopes to characterise the mixture of particles may comprise using the one or more charge envelopes to determine a ratio of the number of particles in the mixture that have the first mass, to the number of particles in the mixture that have the second mass.

The particles may comprise a mixture of capsids or a mixture of viruses.

According to an aspect, there is provided a method of analysing a mixture of capsids, the method comprising:
ionising a mixture of capsids so as to form ions;
separating the ions according to mass to charge ratio by passing the ions through an ion separation device in which one or more time-varying electric fields is used to urge ions through a gas such that ions are separated according to mass to charge ratio;
measuring the transit time of the ions through the ion separation device, and determining a drift time or mass to charge ratio distribution of the ions therefrom;
identifying one or more charge envelopes in the drift time or mass to charge ratio distribution; and
using the one or more charge envelopes to characterise the mixture of capsids.

The mixture of capsids may comprise a mixture of two or more of: (i) capsids that enclose a first amount of genetic material; (ii) capsids that enclose a second different amount of genetic material; and (iii) capsids that are empty of generic material. The first amount of genetic material may be greater than the second amount of genetic material. The first amount of genetic material may be a full or complete amount of genetic material. The second amount of genetic material may be a partial or incomplete amount of genetic material.

Using the one or more charge envelopes to characterise the mixture of capsids may comprise using the one or more charge envelopes to determine one or more of:
a ratio of the number of (i) capsids in the mixture that enclose the first amount of genetic material, to the number of (ii) capsids in the mixture that enclose the second amount of genetic material;
a ratio of the number of (i) capsids in the mixture that enclose the first amount of genetic material, to the number of (iii) capsids in the mixture that are empty of generic material; and
a ratio of the number of (ii) capsids in the mixture that enclose the second amount of genetic material, to the number of (iii) capsids in the mixture that are empty of generic material.

The method may comprise reducing the charge of the ions before separating the ions according to mass to charge ratio.

According to an aspect, there is provided a method of analysing particles with masses >1 MDa, the method comprising:
ionising particles to as to produce ions;
reducing the charge of the ions;
separating the charge-reduced ions according to mass to charge ratio by passing the ions through an ion separation device in which one or more time-varying electric fields is used to urge ions through a gas such that ions are separated according to mass to charge ratio;
measuring the transit time of the ions through the ion separation device, and determining a drift time or mass to charge ratio distribution of the ions therefrom;
using the drift time or mass to charge ratio distribution to characterise the particles.

The ion separation device may be a travelling wave separation device.

The method may comprise successively applying one or more voltages to different electrodes of the device so as to form one or more travelling potential barriers that move along the device so as to urge ions in through the gas.

The method may comprise maintaining the gas in the ion separation device at a pressure ≥0.1 mbar.

The method may comprise ionising the particles at ambient or atmospheric pressure. The method may be performed using an analytical instrument. The method may comprise operating the (entire) analytical instrument at pressures ≥0.1 mbar.

According to an aspect, there is provided an analytical instrument comprising:
an ion source configured to ionise particles to as to produce ions;
an ion separation device arranged downstream of the ion source, wherein the ion separation device is configured to separate ions according to mass to charge ratio by using one or more time-varying electric fields to urge ions through a gas;
an ion detector arranged downstream of the ion separation device, wherein the analytical instrument is configured such that ions eluting from the ion separation device can be detected by the ion detector;
wherein the analytical instrument is configured to measure the transit time of ions through the ion separation device, and to determine a drift time or mass to charge ratio distribution of the ions therefrom; and
wherein the analytical instrument is configured to use the drift time or mass to charge ratio distribution to characterise the particles.

The analytical instrument may be configured to identify one or more charge envelopes in the drift time or mass to charge ratio distribution, and to use the one or more charge envelopes to characterise the particles.

The ion separation device may be configured such that the drift time or mass to charge ratio distribution comprises a drift time or mass to charge ratio distribution in which different charge states of the particles are unresolved.

The analytical instrument may be configured to use the drift time or mass to charge ratio distribution to characterise the particles by using the drift time or mass to charge ratio distribution to characterise the particles without determining a charge or charge distribution of the particles.

The analytical instrument may comprise one or more devices configured to reduce the charge of the ions arranged upstream of the ion separation device.

The ion separation device may be a travelling wave separation device.

The ion separation device may be configured such that the gas in the ion separation device is maintained at a pressure ≥0.1 mbar.

The (entire) analytical instrument may be configured such that the analytical instrument is operated at pressures ≥0.1 mbar.

According to an aspect, there is provided a method of separating and/or characterising high-mass particles according to their bulk m/z ratios, without the need for charge state resolution, the method comprising:
generating gas-phase ions optionally using electrospray ionisation;
separating the ions based on their bulk m/z ratios; and
comparing the bulk m/z ratio patterns obtained with representative results having desired characteristics.

The method may be performed using an apparatus comprising a gas-filled travelling wave (TW) device disposed between an ion source and a detector.

Ions may be delivered to the TW device in packets for subsequent separation.

The TW device may be operated under conditions such that substantially temporal m/z separation is achieved during ion propulsion through the gas.

The ions may be subsequently detected.

### BRIEF DESCRIPTION OF THE DRAWINGS

Various embodiments will now be described, by way of example only, and with reference to the accompanying drawings in which:

FIG. 1 shows schematically an analytical instrument configured in accordance with embodiments;

FIG. 2 shows the percentage reduction in average particle velocity as a function of a and y for a one-dimensional smoothly moving travelling wave device;

FIG. 3 shows schematically an analytical instrument configured in accordance with embodiments;

FIG. 4A shows simulated drift time versus mass to charge ratio results for hypothetical spherical capsids in a T-wave device, and FIG. 4B shows T-wave velocities, amplitudes and the corresponding y and a parameters for mass to charge ratios corresponding to empty and full capsids;

FIG. 5 shows experimental drift time versus mass to charge ratio data for empty and full AAV8 capsids; and

FIG. 6A shows experimental drift time data for empty and full AAV8 capsids, and FIG. 6B shows experimental drift time data for empty and full AAV8 capsids.

### DETAILED DESCRIPTION

In general, it is considered that conventional mass spectrometers (which are configured to separate ions based on their mass to charge ratio (m/z)) have limited utility in the analysis of very large species (other than as a detector), since to derive mass information there must be some means of determining the charge state of the ions being investigated. This is problematic for high-mass particles (which are usually highly charged), where the different charge states are relatively close in m/z, and where sample heterogeneity and/or adducting can render the different charge states unresolvable. Typically, this would be for species with mass >1 MDa.

The Applicant has now recognised that in many cases, charge state resolution is not required to characterise a mixture of particles, but merely sufficient resolution to be able to determine differences in the charge state envelopes of the species present. This means that relatively low-resolution mass analysers can be used to characterise high-mass particle mixtures. For example, in embodiments, the ion separation device may have a resolution of between around 10 and 1000, such as between about 10 and 100.

Thus, embodiments relate to the characterisation of mixtures of high-mass particles using m/z separation. Embodiments provide a method of separating and characterising high-mass particles according to their bulk m/z ratios, without the need for charge state resolution.

The method may include (i) generating gas-phase ions, for example using electrospray ionisation (ESI), (ii) separating the ions based on their bulk m/z ratios, and (iii) comparing the bulk m/z ratio patterns obtained with representative results having desired characteristics.

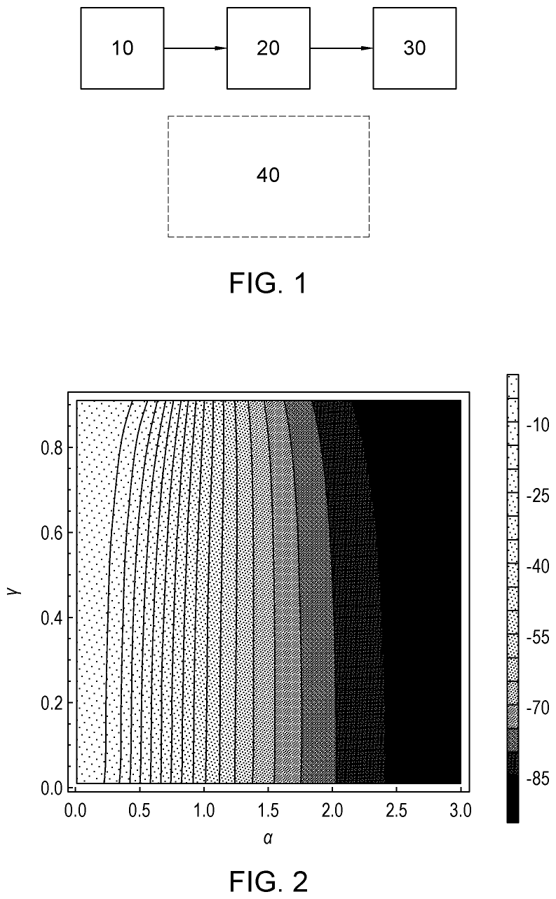

FIG. 1 shows schematically an analytical instrument in the form of a mass spectrometer in accordance with embodiments.

As shown in FIG. 1, the analytical instrument comprises an ion source 10, an ion separation device 20 arranged downstream from the ion source 10, and a detector 30 that is arranged downstream from the ion source 10 and downstream from the ion separation device 20. As illustrated by FIG. 1 the analytical instrument may be configured such that ions can be provided by (sent from) the ion source 10 to the analyser 30 via the ion separation device 20.

As also shown in FIG. 1, the analytical instrument may comprise a control system 40 that is configured to control the operation of the analytical instrument, for example in the manner of the various embodiments described herein. The control system may comprise suitable control circuitry that is configured to cause the instrument to operate in the manner of the various embodiments described herein. The control system may comprise suitable processing circuitry configured to perform any one or more or all of the necessary processing and/or post-processing operations in respect of the various embodiments described herein. The control system may comprise one or more of a suitable computing device, a microprocessor system, a programmable FPGA (field programmable gate array), and the like.

The ion source 10 is configured to ionise particles so as to produce ions. The ion source 10 may comprise any suitable ion source, such as an ambient ionisation ion source, that is, an ion source configured to ionise the particles at ambient or atmospheric pressure.

The ion source 10 may be an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Laser Ablation Electrospray Ionisation (“LAESI”) ion source; (xxviii) a Surface Assisted Laser Desorption Ionisation (“SALDI”) ion source; (xxix) a Low Temperature Plasma (“LTP”) ion source; (xxxi a Helium Plasma Ionisation (“HePI”) ion source; (xxxi) a Rapid Evaporative Ionisation Mass Spectrometry (“REIMS”) ion source; and/or (xxxii) a Laser Assisted Rapid Evaporative Ionisation Mass Spectrometry (“LA-REIMS”) ion source.

In particular embodiments, the ion source 10 is an electrospray ionisation (ESI) ion source, such as a nano-ESI ion source.

The analytical instrument may optionally comprise a chromatography or other separation device (not shown in FIG. 1) upstream of (and coupled to) the ion source 10. The chromatography separation device may comprise a liquid chromatography or gas chromatography device. Alternatively, the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The detector 30 is configured to detect ions received from the ion separation device 20. The analytical instrument may be configured such that ions eluting from the ion separation device 20 are detected by the detector 30. The detector 30 may be configured to detect the number of and/or intensity of ions received at the detector 30 as a function of time.

The detector 30 may comprise any suitable ion detector such as, for example, (i) a faraday cup or cylinder electrode detector; (ii) an electron multiplier detector; and/or (iii) a photomultiplier or scintillation counter detector.

The detector 30 may be operated at a relatively high pressure (i.e. the detector 30 may comprise a high-pressure detector), such as the same pressure as the ion separation device 20 (as described below), in which case the detector 30 may be located in the same chamber as the ion separation device 20. Alternatively, the detector 30 may be located in a separate chamber, e.g. where the separate chamber is linked to a chamber of or a chamber containing the ion separation device 20 by a conductance-limiting aperture. The separate chamber may be maintained at a relatively low pressure, for example by independently pumping that chamber. The separate chamber may be maintained at a pressure (i) <0.00001 mbar; (ii) 0.00001-0.0001 mbar; (iii) 0.0001-0.001 mbar; (iv) 0.001-0.01 mbar; or (iv) 0.01-0.1. In particular embodiments, the separate chamber may be maintained at a pressure around 0.0001 mbar.

The instrument may also include one or more digitisers (not shown in FIG. 1), such as one or more analogue to digital converters (ADC) and/or one or more time to digital converters (TDC), configured to digitise a signal produced by the detector 30, i.e. so as to produce a digitised version of the signal produced by the detector 30.

The ion separation device 20 is configured to receive ions from the ion source 10 (optionally via one or more ion guides or other ion optical elements), separate the ions according to mass to charge ratio (m/z), and then pass the separated ions to the detector 30 for detection (optionally via one or more ion guides or other ion optical elements). Ions may be separated within the ion separation device 20 as they travel through the ion separation device 20.

A separation region of the ion separation device 20 may be filled with a gas, such as an inert (buffer) gas, such as nitrogen. Ions may be separated within the ion separation device 20 according to their mass to charge ratio (m/z) as they pass through the gas.

The (separation region of the) ion separation device 20 may be operated (maintained) at any suitable pressure, such as (i) <0.1 mbar; (ii) 0.1-0.5 mbar; (iii) 0.5-1 mbar; (iv) 1-2 mbar; (v) 2-5 mbar; (vi) 5-10 mbar; (vii) 10-15 mbar; (viii) 15-20 mbar; (ix) 20-25 mbar; (x) 25-30 mbar; or (xi) >30 mbar. In particular embodiments, the (separation region of the) ion separation device 20 is maintained at a pressure between about 0.1 and 20 mbar. Using an ion separation device that is configured to separate ions while they pass through a (relatively high pressure) gas beneficially means that m/z separation can be achieved without requiring high vacuum pumping. Embodiments therefore provide a particularly simple and low-cost method of analysing high-mass particles, and a particularly simple and low-cost analytical instrument.

The ion separation device 20 is configured such that one or more time-varying electric fields is used to urge ions through the gas such that ions are separated according to mass to charge ratio (m/z). In particular embodiments, the ion separation device 20 comprises a travelling wave (TW) ion separation device.

The ion separation device 20 may comprise a plurality of electrodes, e.g. in the form of an ion guide. Electrodes of the ion guide may define an ion path along which ions are transmitted in use.

The ion separation device 20 may comprise any suitable ion guide, such as an ion guide comprising a plurality of electrodes each having an aperture through which ions are transmitted in use (such as a stacked ring (or stacked plate) ion guide), or a segmented quadrupole ion guide. A segmented quadrupole ion guide can provide a more uniform radial distribution of charge states. The ion guide may be a linear (straight) ion guide, or a closed loop or cyclic ion guide.

The ion separation device 20 may comprise one or more voltage sources configured to apply voltages to the electrodes of the ion guide. Voltages may be successively applied to the electrodes of the device 20 so as to form a wave of potential barriers that move in a first direction along the device so as to urge ions in the first direction through the gas.

Where the ion guide comprises a linear ion guide, the first direction may be an axial direction along the length of the ion guide. A travelling wave may be formed along the device 20, moving in a direction from an entrance end to an exit end of the separation device 20. The moving DC potential barrier may urge the ions through the gas towards the exit end of the separation device 20. Where the ion guide comprises a closed loop or cyclic ion guide, the first direction may be a circumferential (azimuth) direction around the circumference of the ion guide. The moving DC potential barrier may urge the ions around the ion guide one or more times.

Ions may be separated according to their mass to charge ratio such that ions having different mass to charge ratios arrive at an exit region of the ion guide at different times, for example such that ions with relatively high mass to charge ratios arrive at the exit region ahead of ions with relatively low mass to charge ratios (or such that ions with relatively low values of mass to charge ratio arrive at the exit region ahead of ions with relatively high values of mass to charge ratio).

Multiple DC potential barriers may be sequentially applied to (and travelled along or around) the separation device 20. The parameters of the DC potential may be selected such that each ion is passed by the DC travelling potentials multiple times as it travels through the separation device 20, i.e. the ion will roll over multiple DC potential barriers. This may be achieved, for example, by selecting an appropriate speed and voltage amplitude for the DC potential barrier.

In embodiments, the amplitude of each DC voltage may be around (i) <1 V; (ii) 1-10 V; (iii) 10-20 V; (iv) 20-30 V; (v) 30-40 V; (vi) 40-50 V; (vii) 50-60 V; (viii) 60-70 V; (ix) 70-80 V; (x) 80-90 V; (xi) 90-100 V; and (xii) >100 V. Each voltage may be applied to an electrode for between around 10⁻⁴ ms and 5 ms. The wave(s) may have any suitable velocity such as around (i) <50 m/s; (ii) 50-100 m/s; (iii) 100-200 m/s; (iv) 200-300 m/s; (v) 300-400 m/s; (vi) 400-500 m/s; (vii) 500-1000 m/s; (viii) 1000-1500 m/s; (ix) 1500-2000 m/s; or (x) >2000 m/s.

Travelling wave (TW) induced ion transport depends on both ion mobility and mass to charge ratio (m/z). As described, for example, in US 2020/0161119, the contents of which are incorporated herein by reference, the m/z dependence has been previously characterized in terms of velocity relaxation, which (for a chosen set of operating parameters) increases with the mass to charge ratio (m/z) of the ions. As such, operating parameters can be tailored to yield separation dominated by either m/z or mobility, or a combination of the two.

The separation characteristics of such a device are conveniently parameterized in terms of the parameters:

$$γ = 2 π \frac{{V}_{0}}{v λ} K , \qquad α = 2 π \frac{v}{λ} \frac{Km}{z} ,$$

where V₀ is the applied wave amplitude, v is the wave velocity, λ is the wavelength and K and m/z are the mobility and mass-to-charge ratio of the particle, respectively.

FIG. 2 shows the percentage reduction in average particle velocity as a function of α and γ for a one-dimensional smoothly moving travelling wave device. Qualitative behaviour in more realistic devices in which ions can move off-axis and in which waves move forward in steps rather than moving smoothly is similar, and can be characterized numerically or in simulation.

At higher values of α, the degree of velocity relaxation (and hence the dependence on m/z ratio) increases. Thus, in embodiments, the parameters of the DC potential may be selected such that ions are separated (predominantly) according to mass to charge ratio.

The applied travelling wave(s) may be smoothly moving or stepped. For stepped waves, the step size may be adjusted to optimize the relative amounts of mass to charge ratio (m/z) and ion mobility separation.

The ion separation device 20 may be operated with or without radially confining RF voltages. Where the ion separation device 20 is operated without radially confining RF voltages, the travelling wave conditions may be chosen to produce sufficient m/z separation and confinement simultaneously.

Where the ion separation device 20 is operated with radially confining RF voltages, the ion separation device 20 may comprise one or more further voltage supplies configured to supply an AC or RF voltage to the electrodes. Opposite phases of an AC or RF voltage may be applied to successive electrodes. The AC or RF voltage may have an amplitude selected from the group consisting of: (i) <50 V peak to peak; (ii) 50-100 V peak to peak; (iii) 100-150 V peak to peak; (iv) 150-200 V peak to peak; (v) 200-250 V peak to peak; (vi) 250-300 V peak to peak; (vii) 300-350 V peak to peak; (viii) 350-400 V peak to peak; (ix) 400-450 V peak to peak; (x) 450-500 V peak to peak; and (xi) >500 V peak to peak. The AC or RF voltage may have a frequency selected from the group consisting of: (i) <100 kHz; (ii) 100-200 kHz; (iii) 200-300 kHz; (iv) 300-400 kHz; (v) 400-500 kHz; (vi) 0.5-1.0 MHz; (vii) 1.0-1.5 MHz; (viii) 1.5-2.0 MHz; (ix) 2.0-2.5 MHz; (x) 2.5-3.0 MHz; (xi) 3.0-3.5 MHz; (xii) 3.5-4.0 MHz; (xiii) 4.0-4.5 MHz; (xiv) 4.5-5.0 MHz; (xv) 5.0-5.5 MHz; (xvi) 5.5-6.0 MHz; (xvii) 6.0-6.5 MHz; (xviii) 6.5-7.0 MHz; (xix) 7.0-7.5 MHz; ( )( )7.5-8.0 MHz; (xxi) 8.0-8.5 MHz; (xxii) 8.5-9.0 MHz; (xxiii) 9.0-9.5 MHz; (xxiv) 9.5-10.0 MHz; and (xxv) >10.0 MHz.

The ion separation device 20 may be configured to (receive and) separate packets (groups) of ions. Where the ion source 10 comprises a pulsed ion source, packets of ions may be generated by the ion source 10.

However, in particular embodiments (where the ion source 10 is either a pulsed or continuous ion source), the analytical instrument furthers comprises an ion trap (not shown in FIG. 1), which may be arranged between the ion source 10 and the ion separation device 20. Ions generated by the ion source 10 may be accumulated in the ion trap, and the ion trap may be configured to pass packets of ions to the ion separation device 20, such as by periodically passing a packet of ions to the ion separation device 20. Each packet of ions may comprise ions of the mixture of particles to be analysed.

The ion trap may comprise any suitable ion trap, such as for example (i) a 2D or linear quadrupole ion trap; (ii) a Paul or 3D quadrupole ion trap; (iii) a Penning ion trap; (iv) a stacked ring ion trap; or (v) another type of ion trap.

In accordance with embodiments, the transit time of the ions passing through the ion separation device 20 is measured. This may be done in respect of one or more or each packet of ions, so as to produce a drift time or mass to charge ratio distribution for the packet(s) of ions. Measurements in respect of multiple packets of ions may optionally be combined to produce a (final) drift time or mass to charge ratio distribution for the particles being analysed.

The time at which a packet of ions is introduced into the ion separation device 20 may correspond to an initial time (time zero), and the transmit time for each ion may be measured as the time difference between the initial time and the time at which that ion is detected by the detector 30. The resulting time distribution may be converted to a mass to charge ratio distribution.

In embodiments, the device may be calibrated such that drift time can be converted to mass to charge ratio (m/z) and/or ion mobility, e.g. using a calibration curve constructed using measurements of particles with known mass to charge ratio (m/z) and/or ion mobility.

Thus, particular embodiments employ a gas-filled ion separation device 20 for mass to charge ratio separation, where a travelling voltage wave (TW) propels ions along the device 20. The device 20 may be implemented between an ion source 10 (for example an electrospray ionisation (ESI) ion source) and a detector 30. Ions may be delivered to the TW device 20 in packets for subsequent separation. The TW device 20 may be operated under conditions such that substantially temporal m/z separation is achieved during ion propulsion through the gas. The ions may be subsequently detected.

This arrangement does not require high vacuum stages or conventional mass analysers. The ion separation device 20 of various embodiments beneficially requires relatively low voltages, and does not require precise control of those voltages. Embodiments therefore provide a particularly simple and low-cost method of analysing high-mass particles, and a particularly simple and low-cost analytical instrument.

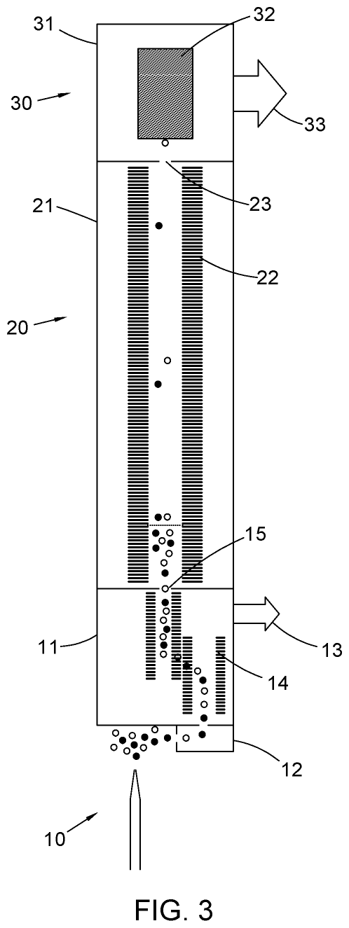

FIG. 3 shows schematically an analytical instrument in the form of a mass spectrometer in accordance with these embodiments. As shown in FIG. 3, the instrument may comprise an ambient ion source 10 in the form of a nano-ESI ion source. Ions generated by the ion source 10 may be sampled into an initial vacuum chamber 11 of the instrument via an atmospheric pressure interface 12.

The initial vacuum chamber 11 may be operated (maintained) at any suitable pressure, such as (i) <1 mbar; (ii) 1-2 mbar; (iii) 2-5 mbar; (iv) 5-10 mbar; (v) 10-15 mbar; (vi) 15-20 mbar; (vii) 20-25 mbar; (viii) 25-30 mbar; or (ix) >30 mbar. In particular embodiments, the initial vacuum chamber 11 is maintained at a pressure between about 1 and 20 mbar. To do this, as shown in FIG. 2, the initial vacuum chamber 11 may be pumped by a backing pump (roughing pump) 13.

As also shown in FIG. 2, one or more ion guides or other ion optical elements 14, e.g. in the form of a dual conjoined ion guide, are provided in the initial vacuum chamber 11, where the one or more ion guides or other ion optical elements 14 are configured to transfer ions received from the atmospheric pressure interface 12 to (and through) an aperture 15 arranged between the initial vacuum chamber 11 and a second vacuum chamber 21 of the analytical instrument.

In the embodiment depicted in FIG. 2, the ion separation device 20 is a travelling wave (TW) ion separation device, which (as described above) comprises a plurality of electrodes in the form of an ion guide 22. The ion guide 22 may be arranged within the second vacuum chamber 22, and the second vacuum chamber 21 may be maintained at a pressure between about 0.1 and 20 mbar.

Once separated by the ion separation device 20, ions are passed to the detector 30 via a second aperture 23 arranged between the second vacuum chamber 21 and a third vacuum chamber 31 of the analytical instrument.

The third vacuum chamber houses (at least) a detection surface 32 of the detector 30, and may be maintained at a pressure of around 0.0001 mbar. To do this, as shown in FIG. 2, the initial third chamber 31 may be pumped by a turbomolecular pump 33.

Although particular embodiments have been described in terms of T-wave mass to charge ratio separation, other separation or filtering devices exploiting time-dependent electric fields in gas-filled cells may be employed, e.g. where at least part of the ion motion exhibits significant velocity relaxation. Thus, for example, the ion separation device 20 may comprise an ion trap and/or sector device optionally driven by a substantially pulsed electric field, such as for example a 3D quadrupole ion trap, a linear ion trap, a toroidal ion trap, a pulsed electric sector filter, a parallel electrode filter, a co-axial electrode filter, and the like.

As described above, embodiments relate to the analysis (characterisation) of high-mass particles. As used herein “high-mass particles” comprise particles which each have a mass >1 MDa. In embodiments, the particles may each have a mass (i) 1-5 MDa; (ii) 5-10 MDa; (iii) 10-50 MDa; (iv) 50-100 MDa; (v) 100-150 MDa; (vi) 150-200; and/or (vii) >200 MDa.

As also described above, when ionised, high mass particles often give rise to highly charged ions, where the different charge states are relatively close in m/z. This means that the different charge states can be unresolvable.

The Applicant has now recognised that there are a number of circumstances where charge state resolution of ions is not required to characterise a mixture of high-mass (>1 MDa) particles, but where mere charge envelope resolution can provide sufficient information to be able to characterise the mixture of particles.

Thus, in embodiments, the drift time or mass to charge ratio distribution may comprise a drift time or mass to charge ratio spectrum in which different charge states of particles in the mixture are unresolved. The drift time or mass to charge ratio distribution may comprise a drift time or mass to charge ratio spectrum in which one or more, most, or each individual (resolved) peak in the spectrum corresponds to a charge envelope for a particular particle in the mixture. As used herein a “charge envelope” is a (resolved) peak in a measured drift time or mass to charge ratio distribution that includes contributions from multiple different charge states for the same particle.

The mixture of particles may comprise particles for which it is known or expected that ions produced from most or all of the particles (or from most or all of the particles of interest) in the mixture will have the same average charge (regardless of the mass). Equally, the mixture of particles may comprise particles for which it is known or expected that ions produced from most or all of the particles (or from most or all of the particles of interest) in the mixture will have the same ion mobility (regardless of the mass). For such particles, differences in (the drift time or mass to charge ratio of) charge envelopes in the drift time or mass to charge ratio distribution will be (predominately) indicative of differences in mass.

In accordance with embodiments, one or more charge envelopes are identified in the drift time or mass to charge ratio distribution, and the one or more charge envelopes are used to characterise the particles.

The one or more charge envelopes may be used to characterise the particles in any suitable manner. For example, the (average) mass to charge ratio, (maximum) intensity, width, and/or area of one or more or each charge envelope may be used to characterise (identify) the particles.

In some embodiments, the one or more charge envelopes may be used for fingerprinting. Thus, the one or more charge envelopes may be used to characterise the particles by comparing the one or more charge envelopes to one or more known charge envelopes, for example in a library. For example, the observed arrival time (or mass to charge ratio) distribution may be compared (statistically, probabilistically or using a variety of multivariate or machine learning methods) with existing patterns in a library or an exemplar pattern. The observed pattern may be identified as corresponding to a library or exemplar pattern, or may be identified as an outlier (i.e. a new pattern).

In particular embodiments, the one or more charge envelopes may be used to characterise the particles by determining an intensity or area ratio between two or more different charge envelopes. Such a ratio may be used to determine ratio(s) of the number of particles in the mixture that have different masses.

For example, the particles may be a mixture of different particles, where each different particle has a different mass (>1 MDa). The mixture of particles may comprise a mixture of first particles having a first mass (>1 MDa) and second particles having a second different mass (>1 MDa). The mixture of particles may comprise one or more third particles having one or more third different masses (>1 MDa). The first mass may be greater than the second mass. The second mass may be greater than the one or more third masses.

The one or more charge envelopes may be used to determine (i) the ratio of the number of particles in the mixture that have the first mass, to the number of particles in the mixture that have the second mass; (ii) the ratio of the number of particles in the mixture that have the first mass, to the number of particles in the mixture that have the one or more third masses; (iii) the ratio of the number of particles in the mixture that have the second mass, to the number of particles in the mixture that have the one or more third masses; and so on.

Embodiments have particular utility in screening approaches, process analysis and quality control/assurance.

A particular example is for quality assurance (QA) and/or quality control (QC) of therapeutics that utilise adeno-associated viruses (AAV).

AAV capsids are common delivery vehicles for vaccines and gene therapies, and have a mass of around 3.5 MDa. During production of the therapeutics (where genetic material is encapsulated in the capsids), a mixture of empty, partially full and full capsids is generally produced. Measurement of the empty/partial/full capsid ratios is a major part of the QA/QC process.

State-of-the-art measurements using charge detection mass spectrometry (CDMS) have revealed that the empty/partial/full AAV capsid ions have a similar average charge (due to them having a similar exposed radius/surface/shape) and differ only by mass, due to incorporation of the genome cargo. This is shown e.g. by the article “Resolving Adeno-Associated Viral Particle Diversity with Charge Detection Mass Spectrometry”, Pierson et al. (Anal Chem. 2016 Jul 5; 88(13): 6718-6725).

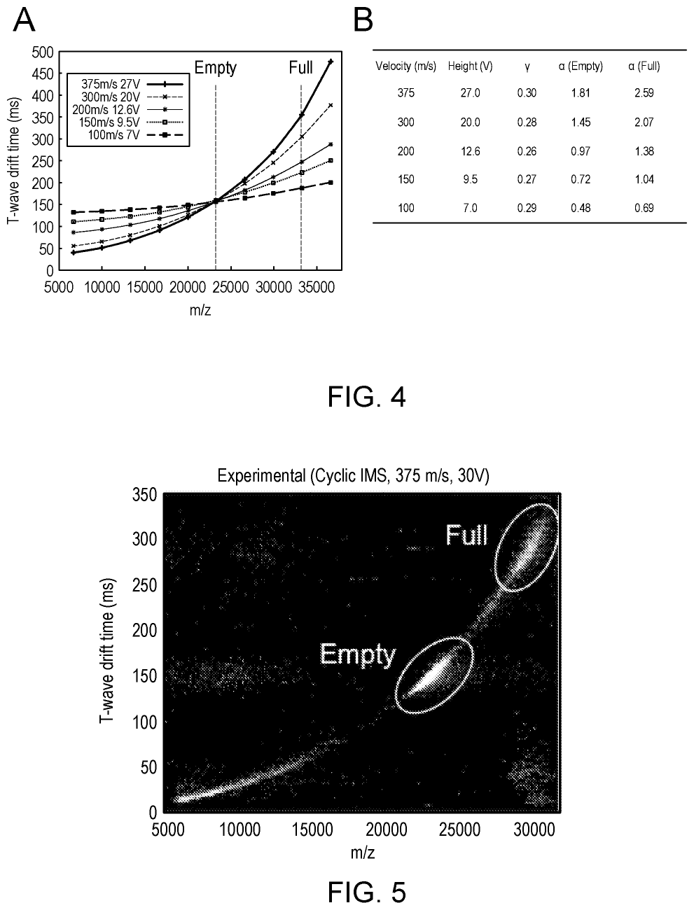

FIG. 4(a) of Pierson et al. shows a CDMS spectrum measured for adeno associated viruses with an sc-GFP genome. The peak at 3.7 MDa is due to empty capsids, and the peak at 5.1 MDa is due to capsids that have packaged the full genome.

The Applicant has recognised that, according to the data given in FIG. 4(a) of Pierson et al., a device with a m/z resolution of ˜20 is sufficient to determine the empty/partial/full capsid ratios. Such resolutions can be obtained using the TW ion separation device 20 described above, in a particularly straightforward manner.

Thus, in embodiments, a mixture of capsids is analysed, where the mixture comprises a mixture of two or more of: (i) capsids that enclose a first amount of genetic material; (ii) capsids that enclose a second different amount of genetic material; and/or (iii) capsids that are empty of generic material. The first amount of genetic material may be greater than the second amount of genetic material. The first amount of genetic material may be a full or complete amount of genetic material. The second amount of genetic material may be a partial or incomplete amount of genetic material.

The one or more charge envelopes may be used to determine one or more of (i) the ratio of the number of capsids in the mixture that enclose the first amount of genetic material, to the number of capsids in the mixture that enclose the second amount of genetic material; (ii) the ratio of the number of capsids in the mixture that enclose the first amount of genetic material, to the number of capsids in the mixture that are empty of generic material; (iii) the ratio of the number of capsids in the mixture that enclose the second amount of genetic material, to the number of capsids in the mixture that are empty of generic material; and the like.

FIG. 4 shows SIMION simulation results for hypothetical spherical capsids of varying density (radius of 125 Å, 150 charges), in a 1 m long T-wave device operating at 1.35 Torr.

FIG. 4A shows the results plotted as m/z versus T-wave drift time. The dashed lines labelled “Empty” and “Full” highlight the T-wave separation of capsids with masses of 3.5 and 5.0 MDa, respectively. FIG. 4B shows T-wave velocities, amplitudes and the corresponding γ and α parameters for m/z ratios of empty and full capsids.

FIG. 4A shows simulation results for hypothetical spherical capsids of varying density (assuming the same average charge of 150 and radius of 125 Å), subjected to separation in the TW device operated at a range of conditions given in FIG. 4B. The m/z ratios expected for the empty and full AAV capsids (3.5 MDa and 5 MDa) are marked with vertical dashed lines.

As is apparent from the dataset obtained with TW velocity of 375 m/s and amplitude of 27 V, a substantial separation of empty and full capsids is observed, with drift times of 110 ms and 250 ms respectively. Expectedly, the separation decreases under TW conditions resulting in lower a parameters (FIG. 4B).

FIG. 5 shows experimental data corresponding to the simulation data of FIG. 4. In particular, FIG. 5 shows ToF (m/z) versus T-wave drift time data for empty and full AAV8 capsids. The data was obtained using a cyclic IMS device with a TW velocity of 375 m/s and amplitude of 30 V. As is apparent from the data, a substantial separation of empty and full capsids is observed.

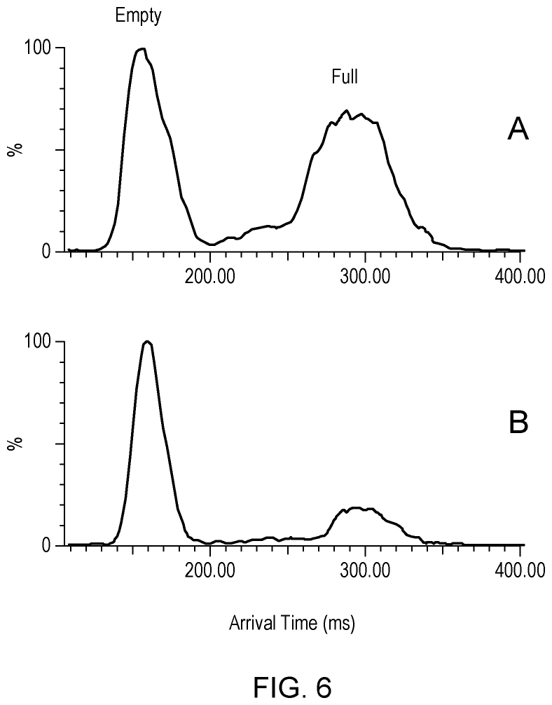

FIG. 6 shows experimental data for T-wave separation of mixtures of empty and full AAV8 capsids, where the data in FIG. 6A is for capsids prepared with a different ratio of empty and full capsids to the data in FIG. 6B. The data were acquired using a cyclic IMS device with a 10 minute acquisition time. As is apparent from the data, the different ratios of empty and full capsids is observed.

Using drift times measured using a TW separator, and assuming that empty and full capsids have the same radius and average charge, the m/z of empty and full capsids can be estimated using an analytical expression, a calibrated analytical expression, or data from a numerical or fully ion-optical simulation in the form of a lookup table. An analytical expression may be, or comprise a term of the form:

$$\overline{v} = \frac{v}{1 + {α}^{2}} [ \frac{{γ}^{2}}{2} + \frac{{γ}^{4}}{8} \frac{1 + 10 {α}^{2} + 15 {α}^{4}}{{( 1 + {α}^{2} )}^{2} ( 1 + 4 {α}^{2} )} + \frac{{γ}^{6}}{16} \frac{1 + 23 {α}^{2} + 234 {α}^{4} + 1171 {α}^{6} + 2291 {α}^{8} + 1620 {α}^{10}}{4 {( 1 + {α}^{2} )}^{4} {( 1 + 4 {α}^{2} )}^{2} ( 1 + 9 {α}^{2} )} ]$$

where v is the travelling wave velocity and v̅ is the measured average ion velocity.

This equation can be solved numerically to find α and hence the m/z ratio of a particle when the travelling wave parameters and ion mobility K of an ion are known. Alternatively, when two such equations are provided, corresponding to different sets of travelling wave conditions that result in different degrees of m/z and mobility separation, they may be solved simultaneously to obtain both m/z and mobility measurements.

The above expression may be extended by including terms proportional to γ⁸, γ¹⁰, etc., and/or it may be modified to describe wave-stepping effects. A calibration step may, for example, comprise rescaling either or both of the parameters α or γ to accommodate deviations from nominal pressure or voltages inside the device, or to accommodate effects such as wave stepping. Additional modifications may be included to describe effects that can be attributed to the differing spatial distributions adopted by populations of ions of different mass and mobility.

A lookup table may comprise a set of simulated average relative ion velocities obtained from simulated ion trajectories at a variety of values of α and γ in a realistic model of a device using a package such as SIMION. Alternatively, it may be populated using values obtained through numerical solution of differential equations describing the particle motion, or the results of previous experiments.

The method according to embodiments can yield a result in a few seconds or a few minutes, and requires a minimal amount of sample, in contrast to conventional approaches (such as analytical ultra-centrifugation, transmission electron microscopy, anion exchange chromatography, etc.).

The relative simplicity and low cost of the T-wave based apparatus is a major advantage, especially for QC applications. For example, the T-wave device described herein can operate in a pressure range between 0.1-20 mbar, and thus does not require high vacuum pumping. The T-wave device described herein can operate with voltage pulse amplitudes between 1-100V and periods of 10⁻⁴ to 5 ms. The required precision in both the period and amplitude voltage is relatively low (1%). Furthermore, the transit time through the T-wave device is between 1 and 1000 ms, thus allowing for relatively slow ion detectors and signal digitizers (0.01-10 ms FWHM pulse width).

These requirements are in contrast with conventional m/z analysers, which require high vacuum (10⁻⁴ to 10⁻⁹ mbar), precise high voltage supplies (several kV), fast detectors (500 ps FWHM pulse width) and fast digitizers (>1 Gs/s).

Although particular embodiments have been described in terms of the analysis of AAV, the approach can be used for a broad range of high mass analytes, such as for example Adeno Viruses (˜150 MDa) when used as a delivery vehicles for vaccines and gene therapies etc. In general, the high mass particles may comprise a mixture of any high mass particles, such as for example viruses, capsids, nanoparticles such as nanoparticles comprising surface active molecules (e.g. vesicles, nano-discs), lipoprotein particles (e.g. cholesterol), polyoxo-metallates and other supramolecular constructs, metal clusters, polymer chains, and the like.

In some embodiments, the results from more than two experiments (for example, under different travelling wave conditions) can be combined and analysed probabilistically or statistically to further improve the quality of the result.

The (T-wave) m/z separator 20 can be operated under at least two different conditions such that mobility and m/z of ions can be extracted. For example, the device can operate using (T-wave) separation at conditions maximizing m/z dependence, and also using a linear electric field to obtain a “pure” mobility separation. The m/z can then be estimated from two datasets.

The separation device 20 may be calibrated using one or more species having a known m/z and ion mobility. This may include, for example, a hollow capsid. The relationship between arrival time and m/z ratio may be parameterized using a polynomial, spline or any other suitable interpolating function.

Measured responses may also be calibrated using standard samples at known concentrations to improve accuracy of (relative) quantitation.

The (T-wave) m/z separator 20 can be implemented in a stand-alone configuration or at various points in a mass spectrometer system. In some embodiments, several (T-wave) m/z separators may be arranged in sequence, optionally with one or more activation, collision, fragmentation, reaction or dissociation stages between them.

For example, the (T-wave) m/z separator 20 can be implemented in tandem with a fast m/z separator (such as a time-of-flight separator). Ions can be dissociated following separation in the (T-wave) separator 20, and a 2D correlation map of precursor and product ions can thereby be obtained.

The (T-wave) m/z separator 20 can be implemented in a quadrupole—T-wave—ToF configuration. Precursor ions can be selected, dissociated partially prior to the T-wave m/z separation, and fully prior to the ToF measurement.

Thus, in embodiments, the detector 30 may comprise a mass analyser, such as a time of flight (ToF) mass analyser.

The analytical instrument may comprise an activation, collision, fragmentation or reaction device (not shown) configured to activate, fragment or react ions. The activation, collision, fragmentation or reaction device may be arranged between the ion separation device 20 and the detector 30.

The activation, collision, fragmentation or reaction device may comprise any suitable device such as one or more activation, collision, fragmentation or reaction cells selected from the group consisting of: (i) a Collisional Induced Dissociation (“CID”) fragmentation device; (ii) a Surface Induced Dissociation (“SID”) fragmentation device; (iii) an Electron Transfer Dissociation (“ETD”) fragmentation device; (iv) an Electron Capture Dissociation (“ECD”) fragmentation device; (v) an Electron Collision or Impact Dissociation fragmentation device; (vi) a Photo Induced Dissociation (“PID”) fragmentation device; (vii) a Laser Induced Dissociation fragmentation device; (viii) an infrared radiation induced dissociation device; (ix) an ultraviolet radiation induced dissociation device; (x) a nozzle-skimmer interface fragmentation device; (xi) an in-source fragmentation device; (xii) an in-source Collision Induced Dissociation fragmentation device; (xiii) a thermal or temperature source fragmentation device; (xiv) an electric field induced fragmentation device; (xv) a magnetic field induced fragmentation device; (xvi) an enzyme digestion or enzyme degradation fragmentation device; (xvii) an ion-ion reaction fragmentation device; (xviii) an ion-molecule reaction fragmentation device; (xix) an ion-atom reaction fragmentation device; (xx) an ion-metastable ion reaction fragmentation device; (xxi) an ion-metastable molecule reaction fragmentation device; (xxii) an ion-metastable atom reaction fragmentation device; (xxiii) an ion-ion reaction device for reacting ions to form adduct or product ions; (xxiv) an ion-molecule reaction device for reacting ions to form adduct or product ions; (xxv) an ion-atom reaction device for reacting ions to form adduct or product ions; (xxvi) an ion-metastable ion reaction device for reacting ions to form adduct or product ions; (xxvii) an ion-metastable molecule reaction device for reacting ions to form adduct or product ions; (xxviii) an ion-metastable atom reaction device for reacting ions to form adduct or product ions; and (xxix) an Electron Ionisation Dissociation (“EID”) fragmentation device.

The analytical instrument may comprise a mass filter, such as a quadrupole mass filter, for example arranged between the ion source 10 and the ion separation device 20.

Although as described above, in particular embodiments, the one or more charge envelopes are used to characterise the particles without determining a charge or, charge distribution of the particles, various other embodiments are possible.

For example, the (T-wave) m/z separator 20 can be used in conjunction with a charge reduction device prior to the separation. This may be done (i) in order to charge reduce ions to the point where charge state peaks can be distinguished, and/or (ii) in order to increase the m/z and thus amplify the velocity relaxation effect. Charge reduction may be induced by any suitable technique(s), such as for example solution additives (charge reducing agents and/or charge reducing surfactants), and/or reactant vapours (comprising either neutral and/or ionised molecules). Evaporation of solution additives may also result in the formation of suitable reactant vapours.

Although the present invention has been described with reference to preferred embodiments, it will be understood by those skilled in the art that various changes in form and detail may be made without departing from the scope of the invention as set forth in the accompanying claims.

1. A method of analysing particles with masses >1 MDa, the method comprising:
ionising particles to as to produce ions;
separating the ions according to mass to charge ratio by passing the ions through an ion separation device in which one or more time-varying electric fields is used to urge ions through a gas such that ions are separated according to mass to charge ratio;
measuring the transit time of the ions through the ion separation device, and determining a drift time or mass to charge ratio distribution of the ions therefrom;
identifying one or more charge envelopes in the drift time or mass to charge ratio distribution; and
using the one or more charge envelopes to characterise the particles.

2. The method of claim 1, wherein the drift time or mass to charge ratio distribution comprises a drift time or mass to charge ratio distribution in which different charge states of the particles are unresolved.

3. The method of claim 1, wherein using the one or more charge envelopes to characterise the particles comprises using the one or more charge envelopes to characterise the particles without determining a charge or charge distribution of the particles.

4. The method of claim 1, wherein the particles comprise particles for which it is known or expected that ions produced from most or all of the particles have the same or similar average charge and/or the same or similar ion mobility.

5. The method of claim 1, wherein using the one or more charge envelopes to characterise the particles comprises comparing the one or more charge envelopes to known charge envelope information.

6. The method of claim 1, wherein:
the particles comprise a mixture of particles having a first mass and particles having a second different mass; and
using the one or more charge envelopes to characterise the mixture of particles comprises using the one or more charge envelopes to determine a ratio of the number of particles in the mixture that have the first mass, to the number of particles in the mixture that have the second mass.

7. The method of claim 1, wherein the particles comprise a mixture of capsids or a mixture of viruses.

8. The method of claim 1, wherein:
the particles comprise a mixture of capsids;
the mixture of capsids comprises a mixture of two or more of: (i) capsids that enclose a first amount of genetic material; (ii) capsids that enclose a second different amount of genetic material; and (iii) capsids that are empty of generic material; and
wherein using the one or more charge envelopes to characterise the mixture of capsids comprises using the one or more charge envelopes to determine one or more of:
a ratio of the number of (i) capsids in the mixture that enclose the first amount of genetic material, to the number of (ii) capsids in the mixture that enclose the second amount of genetic material;
a ratio of the number of (i) capsids in the mixture that enclose the first amount of genetic material, to the number of (iii) capsids in the mixture that are empty of generic material; and
a ratio of the number of (ii) capsids in the mixture that enclose the second amount of genetic material, to the number of (iii) capsids in the mixture that are empty of generic material.

9. The method of claim 1, further comprising reducing the charge of the ions before separating the ions according to mass to charge ratio.

10. A method of analysing particles with masses >1 MDa, the method comprising:
ionising particles to as to produce ions;
reducing the charge of the ions;
separating the charge-reduced ions according to mass to charge ratio by passing the ions through an ion separation device in which one or more time-varying electric fields is used to urge ions through a gas such that ions are separated according to mass to charge ratio;
measuring the transit time of the ions through the ion separation device, and determining a drift time or mass to charge ratio distribution of the ions therefrom;
using the drift time or mass to charge ratio distribution to characterise the particles.

11. The method of claim 1, wherein the ion separation device is a travelling wave separation device, and wherein the method comprises successively applying one or more voltages to different electrodes of the device so as to form one or more travelling potential barriers that move along the device so as to urge ions in through the gas.

12. The method of claim 1, further comprising maintaining the gas in the ion separation device at a pressure ≥0.1 mbar.

13. An analytical instrument comprising:
an ion source configured to ionise particles to as to produce ions;
an ion separation device arranged downstream of the ion source, wherein the ion separation device is configured to separate ions according to mass to charge ratio by using one or more time-varying electric fields to urge ions through a gas;
an ion detector arranged downstream of the ion separation device, wherein the analytical instrument is configured such that ions eluting from the ion separation device can be detected by the ion detector;
wherein the analytical instrument is configured to measure the transit time of ions through the ion separation device, and to determine a drift time or mass to charge ratio distribution of the ions therefrom; and
wherein the analytical instrument is configured to use the drift time or mass to charge ratio distribution to characterise the particles.

14. The analytical instrument of claim 13, wherein the analytical instrument is configured to identify one or more charge envelopes in the drift time or mass to charge ratio distribution, and use the one or more charge envelopes to characterise the particles.

15. The analytical instrument of claim 14, wherein the analytical instrument is configured to use the one or more charge envelopes to characterise the particles without determining a charge or charge distribution of the particles.

16. The analytical instrument of claim 14, wherein the analytical instrument is configured to:
compare the one or more charge envelopes to known charge envelope information; and/or
use the one or more charge envelopes to determine a ratio of the number of particles that have a first mass, to the number of particles that have a second mass.

17. The analytical instrument of claim 13, wherein the ion separation device has a resolution of between around 10 and 1000.

18. The analytical instrument of claim 13, further comprising one or more devices configured to reduce the charge of the ions arranged upstream of the ion separation device.

19. The analytical instrument of claim 13, wherein the ion separation device is a travelling wave separation device.

20. The analytical instrument of claim 13, wherein the ion separation device is configured such that the gas in the ion separation device is maintained at a pressure ≥0.1 mbar.
